(19) United States
(12) Patent Application Publication
(10) Pub. No.: US 2008/0084478 A1
(43) Pub. Date: Apr. 10, 2008

(54) System and method for an in-vivo imaging device with an angled field of view

(76) Inventors: Zvika Gilad, Haifa (IL); Yaniv Birnboim, Shaarey Tiqwa (IL)

Correspondence Address: Pearl Cohen Zedek Latzer, LLP, 1500 Broadway, 12th Floor, New York, NY, 10036, US

(21) Appl. No.: 11/528,627

(22) Filed: Sep. 28, 2006

(51) Int. Cl. G06K 9/00; H04N 5/225; H04N 9/04

(52) U.S. Cl. 348/207.99; 382/128

(57) ABSTRACT

Embodiments of the present invention provide systems and methods for imaging a body lumen using a device with a centerline, where the center of gravity of the device is displaced from the centerline, and the centerline has a radius of curvature. Another embodiment of the present invention provides a system and method for imaging a body lumen using a device with a centerline, where the center of gravity of the device is displaced from the centerline, the device has at least two imagers positioned on opposite ends of the device, and the fields of view of the imagers have respective center lines that intersect.

### FIELD OF THE INVENTION

The present invention relates to a system and method for in-vivo imaging.

### BACKGROUND OF THE INVENTION

In-vivo imaging devices, such as, for example, capsules, may be capable of collecting images of a body lumen while inside the body lumen. Such information may be, for example, a stream of image data or image frames from the body lumen and/or measurements of parameters that are medically useful, such as, for example, pH, temperature, etc. The imaging device may transmit the collected data via a hard-wired or wireless medium, and the collected data may be received by a receiving unit. The received information may be sent from the receiving unit to a workstation to be analyzed and/or displayed. Such a system may be operated by, for example, health care professionals and technicians, in a hospital, or another health facility.

Regions of a body lumen, such as a region referred to as a “z-line”, shown in FIG. 5, may have irregularly curved shapes relative to the trajectory of the imaging device moving through the region. A need exists for imaging devices that may image regions of a body lumen which may be obscured from the field of view of the imaging device.

SUMMARY OF THE INVENTION

An exemplary embodiment of the present invention provides a system and method for imaging a body lumen using an in-vivo imaging device, for example, shaped as a capsule. According to one embodiment of the present invention the in-vivo imaging device may have a centerline, where the center of gravity of the device is displaced from the centerline, and the centerline has a radius of curvature. Another embodiment of the present invention provides a system and method for imaging a body lumen using a device with a centerline, where the center of gravity of the device is displaced from the centerline. According to some embodiments of the present invention the device may include at least two imagers positioned on opposite ends of the device, and the fields of view of the imagers have respective center lines that intersect.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic illustration of an exemplary in-vivo imaging system, including an in-vivo imaging device, a receiving unit and a workstation, in accordance with some embodiments of the invention;

FIG. 2 is a schematic illustration of an in-vivo imaging device, in accordance with an embodiment of the invention;

FIG. 3 is a schematic illustration of an in-vivo imaging device, in accordance with an embodiment of the invention;

FIG. 4 depicts a series of steps for adapting the shape of an imaging device, in accordance with an embodiment of the present invention; and

FIG. 5 is a schematic illustration of an in-vivo imaging device in the Inferior Esophageal Sphincter, in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

Unless specifically stated otherwise, as apparent from the following discussions, it is appreciated that throughout the specification discussions utilizing terms such as “processing,” “computing,” “calculating,” “determining,” or the like, refer to the action and/or processes of a workstation, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

A system according to some embodiments of the invention may include an in-vivo imaging device that generates image data that relates to an image, a frame or a stream of images or frames. A transmitter, for example, in the imaging device, may transmit the image data to areas external to the imaging device. A receiving unit, external to the imaging device, which may be positioned close to or worn on a subject, may receive streams of data transmitted by the transmitter in the imaging device. A workstation may accept, process and/or display the data from the receiving unit, which may include image data and/or data stored in memory areas. A workstation may download or access the stream of data from the receiving unit and may analyze and/or display the stream of data. In one embodiment, the workstation may download, store, use or display the stream of image data separately from the stream of memory data.

Devices according to embodiments of the present invention may be similar to embodiments described in U.S. Pat. No. 7,009,634 to Iddan et al., entitled “Device for In-Vivo Imaging”, and/or in U.S. Pat. No. 5,604,531 to Iddan et al., entitled “In-Vivo Video Camera System”, and/or in U.S. patent application Ser. No. 10/046,541, filed on Jan. 16, 2002, published on Aug. 15, 2002 as United States Patent Application Publication Number 2002/0109774, all of which are hereby incorporated by reference. An external receiving unit, a processor and a workstation, such as those described in the above publications, may be suitable for use with some embodiments of the present invention. Devices and systems as described herein may have other configurations and/or other sets of components. For example, some embodiments of the present invention may be practiced using an endoscope, needle, stent, catheter, etc. In-vivo devices, according to some embodiments, may be capsule shaped, or may have other shapes, for example, a banana shape, a peanut shape or tubular, spherical, conical, or other suitable shapes or may have an adaptive shape as described herein. In some embodiments the imaging device body may have a radius of curvature.

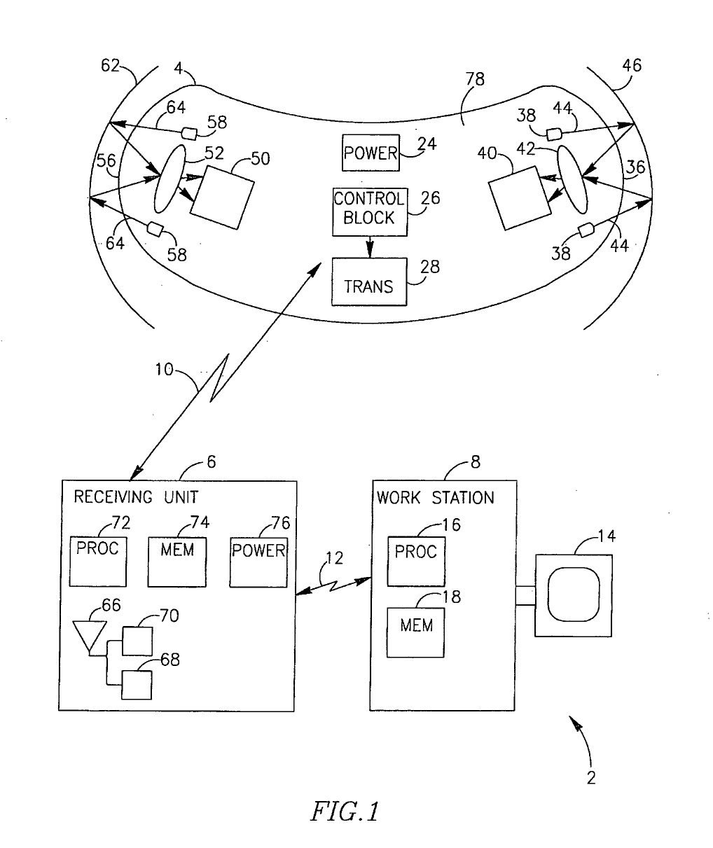

Reference is made to FIG. 1, which is a simplified illustration of an exemplary in-vivo imaging system 2, including an in-vivo imaging device 4, a receiving unit 6, and a workstation 8, in accordance with an embodiment of the invention.

Workstation 8 may include a display unit 14, a processor 16, and a memory 18. Workstation 8 may accept, process and/or display image data received from receiving unit 6.

Receiving unit 6 may include an antenna 66, a receiver 68 and/or a transmitter 70, a processor 72, a memory 74, and a power source 76. Processor 72 may control, at least in part, the operations of receiving unit 6. According to some embodiment of the present invention, imaging device 4 may be a capsule, although other configurations are possible. In some embodiments receiving unit 6 separate from workstation 8 need not be used. Any unit which may receive or accept data transmitted by imaging device 4 may be considered a “receiving unit”.

Receiving unit 6 may communicate with workstation 8 via a medium 12, which may be wireless or hard-wired. For example, receiving unit 6 may be able to transfer bits of wireless communication, for example, memory data, memory data or corresponding image frames that are stored in memory 74, to workstation 8, and may receive control signals, and other digital content, from workstation 8. Although the invention is not limited in this respect, medium 12 may be, for example, a USB cable and may be coupled to a USB controller in receiving unit 6. Alternatively, medium 12 may be wireless, and receiving unit 6 and workstation 8 may communicate wirelessly.

Imaging device 4 may include a power source 24, a control block 26, a transmitter 28, image sensors 40 and 50, and illumination sources 38 and 58. Illumination sources 38 and 58, for example, light emitting diodes (LEDs), may produce light pulses 44 and 64 that may penetrate through optical windows 36 and 56 and may illuminate inner portions 46 and 62 of a body lumen, respectively. Image data of inner portions of a body lumen 46 and 62 may be transmitted, for example, via transmitter 28, from in-vivo imaging device 4 to receiving unit 6 via a wireless or hard-wired medium 10. It may be appreciated by those skilled in the art that, with appropriate modifications, any number of imaging systems may be used according to embodiments of the invention. In one embodiment, all of the components of imaging device 4 are sealed within a device body 78 (the body or shell may include one or more pieces).

Control block 26 may control, at least in part, the operations of imaging device 4. For example, control block 26 may synchronize time periods, in which illumination sources 38 and 58 produce light rays or pulses with time periods in which image sensors 40 and 50 capture images, respectively.

Imaging device 4 typically may be or may include an autonomous swallowable capsule, but imaging device 4 may have other shapes and need not be swallowable or autonomous. Embodiments of imaging device 4 are typically autonomous, and are typically self-contained. For example, imaging device 4 may be a capsule or other unit where all the components including for example power components are substantially contained within a container or shell, and where imaging device 4 does not require any wires or cables to, for example, receive power or transmit information. Imaging device 4 may communicate with an external receiving and display system to provide display of data, control, or other functions. For example, in an autonomous system power may be provided by an internal battery or a wireless receiving system. Other embodiments may have other configurations and capabilities. For example, components may be distributed over multiple sites or units. Control information may be received from an external source.

A non-exhaustive list of examples of body lumens includes the gastrointestinal (GI) tract, a blood vessel, a reproductive tract, or any other suitable body lumen.

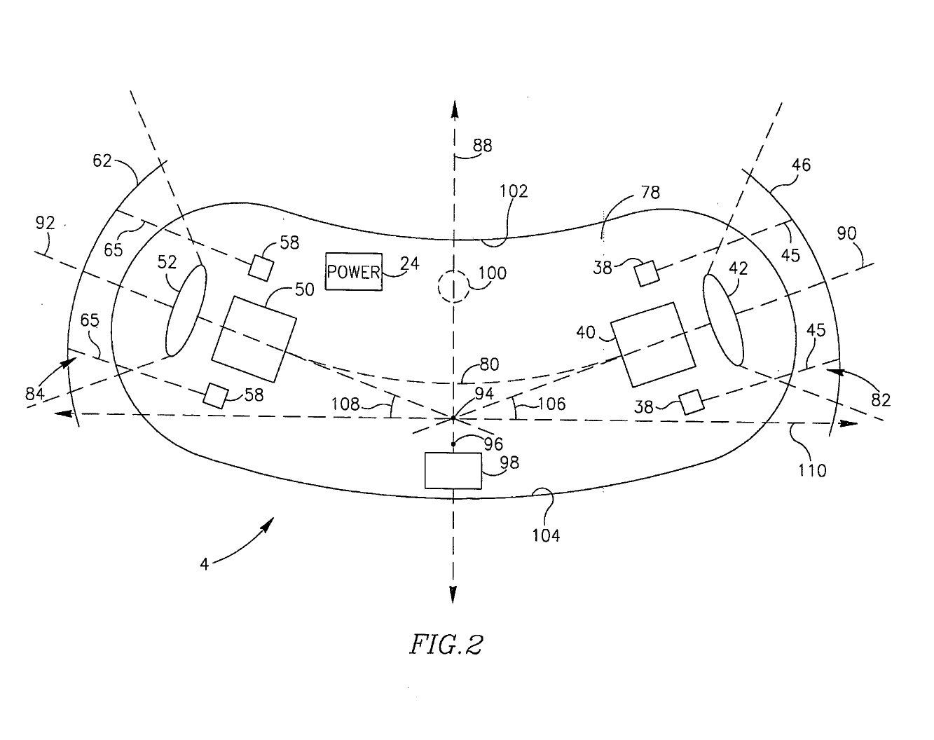

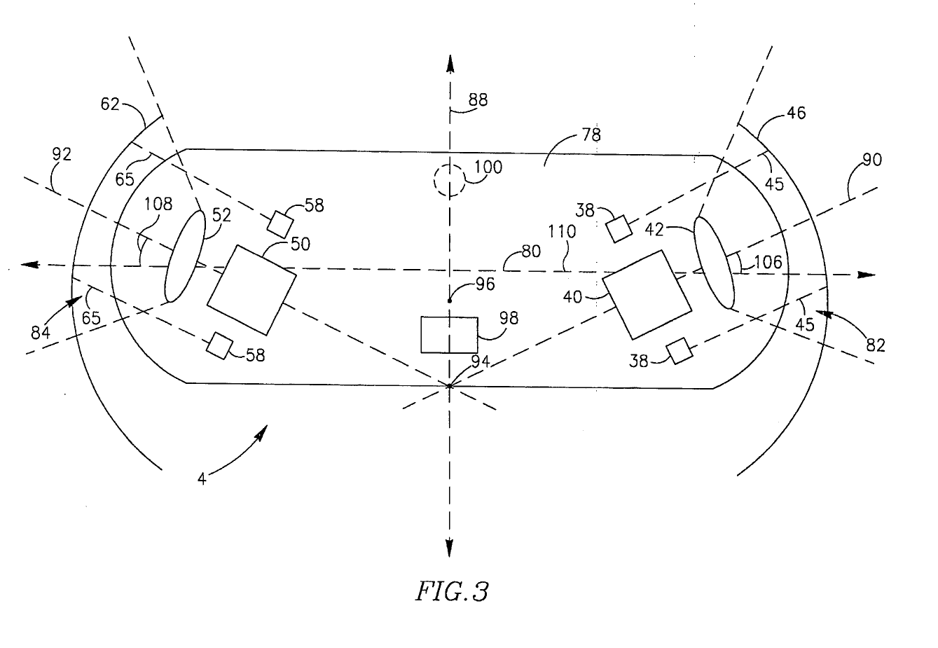

Reference is made to FIGS. 2 and 3, which are schematic illustrations of in-vivo imaging devices, in accordance with an embodiment of the invention. Imaging device 4 may include all the components and capabilities described above in reference to FIG. 1. Imaging device 4 may include a centerline 80, an axis 88, an axis 110, and imaging sensors 40 and 50. Centerline 80 may include all points which are equidistant from the outer surface of imaging device 4. Axes 88 and 110 may be perpendicular to each other and may bisect imaging device 4, for example, at an angle perpendicular to device body 78. In one embodiment, axis 88 may be an axis of symmetry of imaging device 4. Imaging sensors 40 and 50 may have respective fields of view 82 and 84. Fields of view 82 and 84 may be regions from which imaging sensors 40 and 50, respectively, measure light or capture image data. Fields of view 82 and 84 may have centerlines 90 and 92, respectively, which may be all points equidistant from the outer surface of fields of view 82 and 84, respectively. Angles 106 and 108 may be a relative angle between axis 110 and centerlines 90 and 92, respectively. Imaging device 4 may include a center of gravity 96 and a weight 98 and/or a floatation device 100.

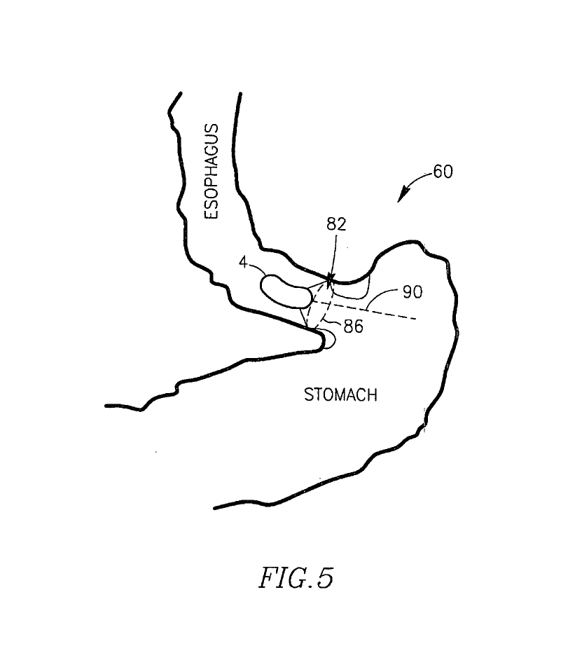

Imaging sensors 40 and 50 may be positioned such that fields of view 82 and 84 have respective centerlines 90 and 92 that intersect at a point of intersection 94. Centerlines 90 and 92 may intersect axis 110 at angles 106 and 108, respectively, so that angles 106 and/or 108 are greater than zero. Such embodiments may provide imaging sensors 40 and 50 positioned for imaging frequently obscured areas of a body lumen, for example, portions of the Inferior Esophageal Sphincter 60, such as a region 86, referred to as a “z-line”, shown more particularly in FIG. 5. In some embodiments of the present invention, imagers 40 and/or 50 may substantially image, and illumination sources 38 and 58 may substantially illuminate, the entirety of z-line 86. In some embodiments, illumination sources 38 and 58, described in detail above in reference to FIG. 1, may fully illuminate fields of view 82 and 84, respectively. For example, centerlines 45 and 65 of light pulses 44 and 64, emitted from illumination sources 38 and 58, respectively, may be parallel to centerlines 90 and 92 of fields of view 82 and 84, respectively In one embodiment, fields of view 82 and/or 84 may be substantially equivalent in scope to regions of the body lumen illuminated by illumination sources 38 and 58, respectively, which may be substantially equivalent in to z-line 86 or a cross-section thereof.

There are many designs and arrangements of components that may provide embodiments according to the present invention. Two examples are illustrated in reference to FIGS. 2 and 3.

In one embodiment illustrated in FIG. 2, centerline 80 may have a radius of curvature. The radius of curvature at a point along a line may be the distance from the center of a sphere or ellipsoid that shares a common tangent with the line at that point. For example, a straight line has no radius of curvature. In various embodiments, centerline 80 may have a curvature greater than zero or may deviate from being straight. In some embodiments, imaging sensors 40 and/or 50 may be positioned along or adjacent to centerline 80. In such embodiments, fields of view 82 and 84 may have respective centerlines 90 and 92 that intersect at point of intersection 94. In an exemplary embodiment, since centerline 80 may have a radius of curvature, angle 106 and/or angle 108 may be greater than zero, for example, in a range from about 5 to about 10 degrees. Other angles may be used. In some embodiments, centerline 80 may or may not have a constant radius of curvature. For example, only a portion of centerline 80 may have a radius of curvature.

According to embodiments of the present invention, imaging device 4 may have an adaptive shape for, when activated, changing the orientation of imaging device 4 and therefore the orientation and/or curvature of centerline 80, between being substantially straight or having substantially no radius of curvature and being substantially curved and substantially having a radius of curvature. In one embodiment, when deactivated centerline 80 does not have a radius of curvature. An alternate embodiment may include a shape memory material that changes the orientation of centerline 80 to have a radius of curvature. In other embodiments, the shape memory material may change the curvature of centerline 80 from greater than zero to about zero, and preferably zero. In some embodiments, imaging device 4 may include shape memory material. Shape memory material may include any of the known shape memory alloys or shape memory polymers, is incorporated, according to an embodiment of the invention, into device body 78 so as to enable deflection of device body 78. For example, in various embodiments, substantially the entire device body 78 or any portion of device body 78, such as either end of device body 78, or strips along device body 78 or material in the proximity of device body 78, are made of a shape memory material. Alternately, the shape memory material may be adjacent to or attached to device body 78. In other embodiments, shape memory material may be internal to device body 78, for example, extending substantially along centerline 80, for example, coating a heating rod. The shape memory material may be bent to various configurations in response to changes in temperature. Thus, different natural or induced in-vivo environments having different temperatures may be used to deflect the shape memory material in various directions thereby achieving flexibility and, according to one embodiment, changing the curvature of centerline 80, so that centerline 80 has a radius of curvature.

In another embodiment, imaging device 4, having centerline 80 without a radius of curvature, may be swallowed. In such embodiments, imaging device 4 may be very flexible such that the shape of imaging device 4 may conform to the shape of the body lumen. When imaging device 4 approaches a region, for example, the Inferior Esophageal Sphincter, it may already be shaped to image z-line 86, according to embodiments of the present invention.

The portion of device body 78 having an adaptive shape may include heat conveying elements, such as one or more wires embedded in or adjacent to device body 78. Other heat conveying elements may be used. Typically, the heat conveying elements may be connected to a power source 24, and may be embedded in device body 78 at a location suitable for effecting a temperature change in the vicinity of the shape memory material. When the shape memory material portion is heated typically to above the transition temperature of the shape memory material or deformable material such as the polyurethane material of device body 78, the material of device body 78 goes through a conformational change as pre programmed, for example, changing the curvature of centerline 80, so that centerline 80 has a radius of curvature. In some embodiments, activating the shape memory material portion may change the curvature of device body 78, so that surface curvature of device body 78 has a radius of curvature. In such embodiments, activating the shape memory material portion may change the surface curvature of device body 78 to be greater than zero.

Examples of imaging devices containing shape memory material that may be used with embodiments of the present invention are described, for example, in U.S. application Ser. No. 10/213,345, entitled “Maneuverable In Vivo Device and Method” to Glukhovsky, which is assigned to the common assignee of the present invention and which is incorporated herein by reference.

According to some embodiments, image sensors 40 and 50 may be connected to a flexible circuit board for reducing tension on components of imaging device 4 that may result from changes in the shape of imaging device 4. Examples of imaging devices containing flexible circuit boards that may be used with embodiments of the present invention are described, for example, in U.S. application Ser. No. 10/879,054 entitled “In Vivo Device with Flexible Circuit Board and Method for Assembly Thereof” to Gilad, which is assigned to the common assignee of the present invention and which is incorporated by reference.

In one embodiment illustrated in FIG. 3, imaging device 4 may include imaging sensors 40 and 50 positioned on opposite ends of imaging device 4 having fields of view 82 and 84 with respective centerlines 90 and 92 that intersect at a point of intersection 94. Centerlines 90 and 92 may intersect axis 110 at angles 106 and 108, respectively, so that angles 106 and/or 108 are greater than zero, for example, in a range from about 5 to about 10 degrees. Other angles may be used. In some but not all embodiments, point of intersection 94 may lie near or on axis 88.

In such embodiments, centerline 80 need not have a radius of curvature. However, imaging device 4 having centerline 80, a portion or all of which has a radius of curvature, may also be used.

In some embodiments, imaging device 4 may include moveable parts for, when activated, positioning imaging sensors 40 and 50 so that fields of view 82 and 84 have respective centerlines 90 and 92 that intersect at point of intersection 94. For example, when the moveable parts are deactivated, imaging sensors 40 and 50 may have respective fields of view that temporarily share a substantially common centerline. In one embodiment, imaging device 4 may include shape memory material as described herein, adapted for, when activated, changing the fields of view 82 and 84 of the imaging sensors 40 and 50, respectively, so that centerlines 90 and 92 intersect. In other embodiments, imaging device 4 may include a wide variety of mechanical linkages, for example, a series of gears or a moveable pulley or weight that may pivot imaging sensors 40 and 50 and thus change their fields of view 82 and 84, respectively. In other embodiments, imaging device 4 may include mirrors, which may be for example moveable or activated by altering a reflective index, to alter fields of view 82 and 84. Activating the moveable parts may be done automatically, for example, after a period of time measured by an internal or external timer (not shown), or may be activated at a user's request, for example, communicated to imaging device 4 via a signal from workstation 8 and/or receiver 6.

With respect to imaging devices 4 discussed in reference to FIGS. 2 and 3, center of gravity 96 may be displaced from centerline 80 for orienting imaging device 4 so that imaging sensors 40 and 50 have desirable fields of view 82 and 84, respectively, for example, for imaging irregularly curved regions of a body lumen, such as the Inferior Esophageal Sphincter. In some embodiments, center of gravity 96 of imaging device 4 may be displaced from centerline 80, for example, using weight 98, floatation device 100, and/or an arrangement of components in imaging device 4. In some embodiments, center of gravity 96 may be displaced along axis 88. Weight 98 may be any substance that decreases the buoyancy of imaging device 4 and flotation device 100 may be any substance that increases the buoyancy of imaging device 4. Weight 98 may include any sufficiently heavy material, including, metals, plastics, etc. Flotation device 100 may include a housing, made of, for example, plastic such as isoplast, where the housing contains a substance lighter than liquid in the body lumen, such as gaseous CO₂, O₂ and/or air. Flotation device 100 may be positioned toward a convex inner surface 102 and weight 98 may be positioned toward a concave inner surface 104. Imaging device 4 may be positively, negatively or neutrally buoyant in a body lumen, regardless of whether or not imaging device 4 includes weight 98 and/or floatation device 100.

In one embodiment, floatation device 100 may be inactive while in a package and may only increase the buoyancy of imaging device 4 when activated. For example, floatation device 100 may be an elastic compartment containing air that inflates when activated to a level sufficient for decreasing the buoyancy of imaging device 4. In one embodiment, activation may occur by releasing floatation device 100 from a packaging, for example, manually or automatically, at a desired location in-vivo. For example, floatation device 100 may contain gas releasing granules such as crystalline sodium bicarbonate, E-Z GasII effervescent granules by EZEM of NY, USA or similar oxygen releasing granules. Typically, these granules release gas (such as CO₂ or oxygen) upon contacting liquid. Floatation device 100, positioned internal or external to imaging device 4, may be exposed to liquid and activate. In another embodiment the packaging may be affected by degradable sutures known in the art, such that the packaging of floatation device 100 is released when the suture is degraded.

In another embodiment, activation of floatation device 100 may occur automatically, for example, by receiving a signal from a remote device, in response to a sensed stimulus or after a predetermined time interval. For example, imaging device 4 may include a gelatin device body 78, such as gelatin capsules provided by Capsugel USA, that may dissolve at a specific location along the GI tract, as known in the field of sustained release mechanisms. In other embodiments, activation of floatation device 100 may occur after a preselected period of time measured by an internal or external timer or at a user's request, for example, communicated to imaging device 4 wirelessly via a signal from workstation 8 and/or receiver 6.

Examples of floatation devices 100 that may be used with embodiments of the present invention are described, for example, in US Publication Number 2003/0018280 A1, entitled “Floatable In Vivo Sensing Device and Method for Use” to Lewkowicz, which is assigned to the common assignee of the present invention and which is incorporated by reference.

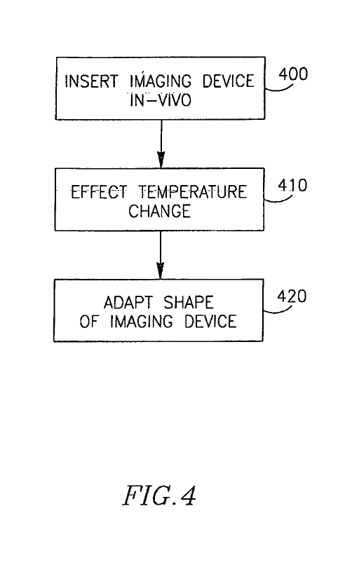

Reference is now made to FIG. 4, which depicts a series of steps for adapting the shape of an imaging device, in accordance with an embodiment of the invention.

In step 400 an imaging device is inserted in-vivo, where the imaging device may have a centerline, a center of gravity that may be displaced from the centerline, and activatable shape memory material adapted for changing the orientation of the centerline so that the centerline has a radius of curvature. The shape memory material may be, for example, embedded, adjacent, interior or exterior to a device body of the imaging device.

In step 410 a temperature change is effected in the vicinity of the shape memory material, for example, by heating. According to one embodiment the shape memory material may be heated by heating wires, such as electrically conductive wires, that may be embedded in or adjacent to the shape memory material.

In step 420, movement may be effected and the shape of the imaging device may be adapted or undergo an action, motion or configurational change. For example, a portion of the imaging device bends or rotates. The shape memory material may be differentially heated to achieve the desired configurational change. In some embodiments, such motion may cause a change in the curvature of a centerline of the imaging device so that the centerline has a radius of curvature. In other embodiments, the orientation of the centerline of the imaging device may not change and the centerline may not have a radius of curvature. In such embodiments, the position of imaging sensors relative to the centerline of the imaging device may change so that the fields of view of the imaging sensors have respective centerlines that intersect at a point of intersection.

In one embodiment, adapting the shape includes changing the orientation of a centerline of the imaging device, so that the centerline has a radius of curvature. In other embodiments, adapting the shape includes changing the position of imaging sensors relative to a centerline of the imaging device so that the fields of view of the imaging sensors have respective centerlines that intersect at a point of intersection. Such embodiments may provide imaging devices that may image regions of a body lumen having irregularly curved shapes, such as, the Inferior Esophageal Sphincter.

It will be appreciated by persons skilled in the art that systems and methods that suitably combine any of the above described embodiments, are also included in the present invention. It will be appreciated that the present invention is not limited to what has been particularly shown and described hereinabove. Rather the scope of the present invention is defined only by the claims which follow:

1. An imaging device for imaging a body lumen, wherein the device comprises a center of
gravity and a centerline having a radius of curvature; and
wherein the center of gravity of the device is displaced from the centerline.

2. The imaging device of claim 1, wherein the center of gravity of the device is displaced along an axis of symmetry of the device.

3. The imaging device of claim 1, comprising at least two imagers each having a field of view, wherein the imagers are positioned on opposite ends of the device.

4. The imaging device of claim 3, wherein the fields of view of the imagers have respective center lines that intersect.

5. The imaging device of claim 3, further comprising two illumination sources positioned on opposite ends of the device, wherein the illumination sources illuminate the fields of view of the imagers.

6. The imaging device of claim 3, wherein the imaging device has a curved capsule shape.

7. The imaging device of claim 1 comprising a substance that increases the buoyancy of the device.

8. The imaging device of claim 1 comprising a substance that decreases the buoyancy of the device.

9. The imaging device of claim 8, wherein the device comprises activatable shape memory material adapted for changing the orientation of the centerline between being substantially straight and substantially having a radius of curvature.

10. The imaging device of claim 1, wherein the imaging device is substantially flexible for conforming to the shape of the body lumen.

11. An imaging device for imaging a body lumen, wherein the device comprises a center of gravity displaced from the centerline; and
at least two imagers, each having a field of view, positioned on opposite ends of the device, wherein the fields of view of the imagers have respective center lines that intersect.

12. The imaging device of claim 11, further comprising two illumination sources positioned on opposite ends of the device, wherein the illumination sources illuminate the fields of view of the imagers.

13. The imaging device of claim 1I, wherein the center of gravity of the device is displaced along an axis of symmetry of the fields of view of the respective imagers.

14. An in vivo imaging system, comprising:
a receiver for receiving in vivo image data; and
an imaging device for transmitting the in vivo image data to the receiver, wherein the imaging device comprises a centerline and a center of gravity, wherein the center of gravity of the imaging device is displaced from the centerline, and the centerline has a radius of curvature.

15. The in vivo imaging system of claim 14, wherein the center of gravity of the imaging device is displaced along an axis of symmetry of the device.

16. The in vivo imaging system of claim 14, wherein the imaging device further comprises at least two imagers, each having a field of view, wherein the imagers are positioned on opposite ends of the device.

17. The in vivo imaging system of claim 16, wherein the fields of view of the imagers have respective center lines that intersect.

18. The in vivo imaging system of claim 16, wherein the imaging device further comprises two illumination sources positioned on opposite ends of the imaging device, wherein the illumination sources illuminate the fields of view of the imagers.

19. The in vivo imaging system of claim 16, wherein the imaging device comprises a curved capsule shape.

20. The in vivo imaging system of claim 14, wherein the imaging device further comprises a substance that increases the buoyancy of the device.

21. The in vivo imaging system of claim 14, wherein the imaging device further comprises a substance that decreases the buoyancy of the device.
